(19) United States
(12) Patent Application Publication
(10) Pub. No.: US 2004/0148103 A1
(43) Pub. Date: Jul. 29, 2004

(54) Grid terrain data collision detecting method for forward looking terrain avoidance

(75) Inventors: Day-Woei Chiuo, Taoyuan Hsein (TW); Kuang-Peng Ho, Taoyuan Hsein (TW); Shin-Jen Chen, Taipei (TW)

Correspondence Address: JOHNSON & ASSOCIATES PC, 14625 BALTIMORE AVENUE #282, LAUREL, MD, 20707, US

(73) Assignee: Chung-Shan Institute of Science and Technology

(21) Appl. No.: 10/342,385

(22) Filed: Jan. 15, 2003

(51) Int. Cl. G06F 7/00

(52) U.S. Cl. 701/301; 701/10

(57) ABSTRACT

A grid terrain data collision detecting method for forward looking terrain avoidance comprising the following steps: the use of kinematics equation to analytically find out sampling points positions; processing the sampling points in sequence with time increments; and using function minimum value theory to detect collision with results obtained from the sampling point process step.

### BACKGROUND OF THE INVENTION

1. Field of the Invention

The present invention relates to a grid terrain data collision detecting method for forward looking terrain avoidance. Specifically, the present invention relates to a grid terrain data collision method that uses kinematics analysis to calculate sampling position and incorporates aircraft kinematics equations, which is used to correlate the resolution of terrains. More specifically, the present invention relates to the incorporation of kinematics equations and function minimum value theory to enable one time comparison of terrain sampling points, so as to improve the efficiency and eliminate any probability, thus ensuring nearly a 100% security.

2.Related Prior Art

FAA TSO-C15a suggests that a Terrain Awareness and Warning System (TAWS) is capable of providing Forward Looking Terrain Avoidance (FLTA) function. The function of FLTA can provide a prediction path for comparison with grid terrain data to determine the possibility of collision.

Traditional approaches of determining the possibility of collision involve sampling of a predictable path at positions with fixed interval and comparing the height of an aircraft at sampling positions with grid terrain data to determine whether there is any possibility of collision. The grid terrain data is required with lower resolution over lower level security region, but with higher resolution over higher level security region.

However, traditional approaches have been determined to have several noticeable flaws. Leaks arise by using fixed interval sampling position, as shown in FIG. 1; and if there is a higher grid terrain within the sampling position intervals, there is a possible cause of danger. If sampling frequency is to be increased for sake of enhancing security, the calculation time required is also increased and yet the security is not nearly 100% secured. If resolution of terrain data is to be increased to improve security, the data storing space has to be increased accordingly and the sampling frequency also needs to be increased as well. Although the detection accuracy can be improved, the security is not yet 100% secured.

In the aforementioned prior art, the security of the fixed interval position sampling detection method is linked to probabilities and the probabilities are linked to terrain data resolution, the position of an aircraft and the predictable path. In practical application, due to limitation of the prior art system resources, the sampling frequency and the terrain data resolution are also limited, thus the security is not nearly 100% secured. In contrast, the grid terrain data collision detecting method for forward looking terrain avoidance of the present invention, using analytical method not only increases system efficiency, but also ensures nearly 100% security.

### SUMMARY OF THE INVENTION

On object of the grid terrain data collision detecting method for forward looking terrain avoidance of the present invention is to use analytical methods to calculate kinematics sampling positions, as shown in FIG. 2.

Another object of the present invention relates to a grid terrain data collision detecting method for forward looking terrain avoidance, which uses kinematics analysis to calculate sampling position, sampling method to incorporate aircraft kinematics equation and correlation for terrain resolution.

Still, another object of this invention is to have a grid terrain data collision detection method capable of ensuring approximately 100% security.

Further another object of this invention is to incorporate kinematics equation and function minimum value theory to enable one time comparison of sampling points of a sampled terrain, so as to improve the efficiency of the data collision detection method.

The present invention will be readily apparent upon reading the following description of a preferred exemplified embodiment of the invention and upon reference to the accompanying drawings.

### BRIEF DESCRIPTION OF THE DRAWINGS

FIG. 1 shows a diagram illustrating traditional fixed interval position sampling and comparative grid.

FIG. 2 shows a diagram illustrating the grid terrain data collision detecting method for forward looking terrain avoidance of the present invention using an analytical method to calculate kinematics sampling and the comparative grids.

FIG. 3 shows a diagram illustrating the grid terrain data collision detecting method for forward looking terrain avoidance of the present invention using a coordinate and terrain data format.

FIG. 4 is a diagram illustrating the grid terrain data collision detecting method for forward looking terrain avoidance of the present invention using aircraft predictable path and its relevant physical quantity.

FIG. 5 is a diagram illustrating the grid terrain data collision detecting method for forward looking terrain avoidance of the present invention using kinematics equation and timing relationship with sampling position.

FIG. 6 is a simulated terrain data chart used in the grid terrain data collision detecting method for forward looking terrain avoidance of the present invention.

FIG. 7 a diagram illustrating the grid terrain data collision detecting method for forward looking terrain avoidance of the present invention using a predictable path to demonstrate relationship between aircraft and collision hazard.

FIG. 8 is a safety comparison between traditional detection method and the grid terrain data collision detecting method for forward looking terrain avoidance of the present invention.

### DETAILED DESCRIPTION AND PREFERRED EMBODIMENT

The present invention relates to a grid terrain data collision detecting method for forward looking terrain avoidance. Specifically, the present invention relates to a grid terrain data collision method that uses kinematics analysis to calculate sampling position and incorporates aircraft kinematics equations, which is used to correlate the resolution of terrains. More specifically, the present invention relates to the incorporation of kinematics equations and function minimum value theory to enable one time comparison of terrain sampling points, so as to improve the efficiency and eliminate any probability, thus ensuring nearly a 100% security.

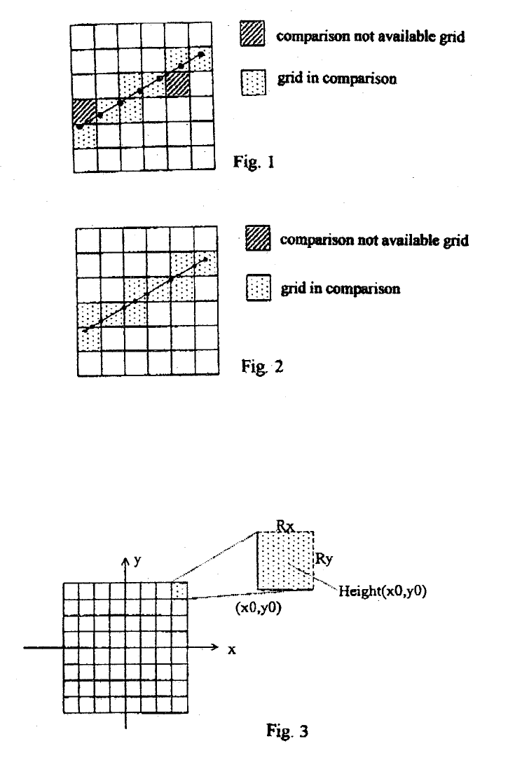

Referring figures of the specification, FIG. 1 shows a diagram illustrating traditional fixed interval position sampling and comparative grid. FIG. 2 shows a diagram illustrating the grid terrain data collision detecting method for forward looking terrain avoidance of the present invention using an analytical method to calculate kinematics sampling and the comparative grids.

In FIG. 3 shows a diagram illustrating the grid terrain data collision detecting method for forward looking terrain avoidance of the present invention using a coordinate system, wherein the resolution may differ from X to Y and the grid terrain data of coordinates (X0′Y0) can be represented by heights (X0′Y0). The region represented by this grid terrain data can be expressed as follows:

{(X,Y)|X0≦X<X0+Rx′Y0≦Y<Y0+Ry}

wherein, Rx represents resolution of the X the axis and Ry represents resolution of the Y axis.

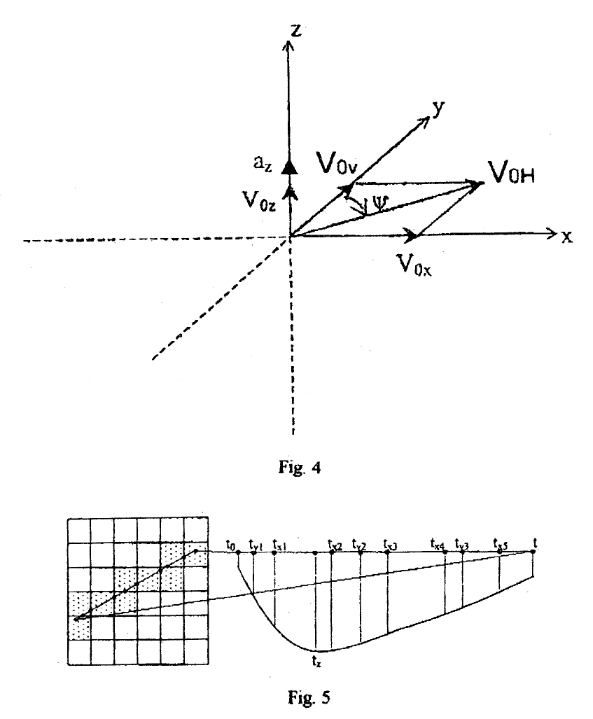

FIG. 4 shows a diagram illustrating the grid terrain data collision detecting method for forward looking terrain avoidance of the present invention using aircraft kinematics equation to predict a future flight path based on the status of an aircraft to avoid forward looking terrain hazard. The kinematics equation used in the present invention are:

Vₓ=V₀ₓ=V_{0H} sin ψ (1)

V_{y}=V_{0y}=V_{0y} cos ψ (2)

V_{z}=V_{0z}+a_{z}t (3)

x=x₀+V_{0H} sin ψ×t (4)

y=y₀+V_{0H} cos ψ×t (5)

z=z₀+V_{0z}t+½ a_{z}t² (6)

wherein V is speed, a is acceleration speed, ψ is directional angle x, y are coordinates, z is height, t is time (with range t₀−0˜t_{f}), the subscripts x, y, z represent the physical quantities in each coordinate respectively, subscript 0 represents initial physical quantity and subscript H represents physical quantity in the xy plane.

These quantities are shown in FIG. 4, which illustrates through an equation an aircraft moving with linear constant speed in the xy plane, but moving with upward and downward accelerating velocity along the z axis.

As a preferred embodiment of the invention, FIG. 5 illustrates the three process steps of the grid terrain data collision detecting method for forward looking terrain avoidance of the present invention: step 1 uses kinematics equation to analytically find out the position sampling points; step 2 processes the sampling points in sequence with time increment; and step 3 uses function minimum value theory to detect collision with the result from step 2.

First, the grid terrain data collision detecting method for forward looking terrain avoidance of the present invention finds out the position sampling points by using kinematics equations to determine the timing of the sampling points. This method commences by first finding the cross point of the flight path and parallel lines of the y axis. These lines have X coordinates equation m_{X} times R_{X}; the equation of parallel lines of the y axis is given below as:

x=mx×R_{X} (7);

wherein combining kinematics equations (4) and (7) yields the crossing timing with parallel lines equation of the of y axis below:

t_{X}=(mx×R_{X}−X₀)/V_{0H} sin ψ (8)

Referring to FIG. 5, from eq. (8) one can find the timing of the following sampling points: t_{X1}, t_{X2}, t_{X3}, t_{X4} and t_{X5}. The process is similar to finding the cross points of the flight path and the parallel lines of X axis. The equation for determining the parallel lines of the X axis is given as:

y=my×Ry (9);

wherein, Ry is an integer and by combining eq. (5) and (9) yields the crossing timing with parallel lines of the y axis as:

ty=(my×Ry−y₀)/V_{0H} con ψ (10)

Still referring to FIG. 5, one can find sampling timing t_{y1}, t_{y2}, and t_{y3} from eq. (8). When the aircraft is flying at utmost north or utmost south positions, that is, the directional angle is 0 or 180 degree, eq. (8) yields a peculiar and specific value. Similarly, when the aircraft is flying at utmost east or utmost west positions, that is, the directional angle is 90 or 270 degree, eq. (10) yields a specific and peculiar value. Therefore, the directional angle must be judged before applying either equation 8 or 10. If the directional angle is 0 or 180 degree, the aircraft will only cross with parallel lines of the X axis, and by using eq. (10) one is able to find the positions of the sampling points. Similarly, if the directional angle is 90 or 270 degree, the aircraft will only cross with parallel lines of the Y axis, and by using eq. (8) one is able to find the positions of sampling points.

Second, the grid terrain data collision detecting method for forward looking terrain avoidance of the present invention processes the sampling points in sequence based on time increments. The results from first step, the crossing points of parallel lines of X and Y axis, are not continuous, thus a line of the flight path can not be formed. However, one can use timing as a clue to arrange two sets of sampling points in sequence based on time increments, such as the relationship shown in FIG. 5; wherein

t₀<t_{y1}<tₓ₁<tₓ₂<t_{y2}<tₓ₃<tₓ₄<t_{y3}<tₓ₅<t_{f}°

Third, the grid terrain data collision detecting method for forward looking terrain avoidance of the present invention uses function minimum value theory to detect collision with the results from step 2 above. Referring to FIG. 5 assume the vertical velocity is downward and the vertical accelerating velocity is also downward, by application of the function minimum value theory to differentiate eq. (6) and setting the results equal to zero to yield the timing of the lowest point as:

t_{Z}=−(V_{0Z}/a_{Z})

The timing can be used as a checking point while proceeding with the collision detection step. The following results were observed using FIG. 5, as an example, to compare one by one each section of the lines:

For line section [to′ty1] , the flying height at this time is decremental, thus the minimum flying height occurred at ty1, so substitute ty1 into eq. (6) to obtain the height at the time and compare with the height of the grids;

For line section [ty1′tx1], the flying height at this time is decremental, thus the minimum flying height occurred at tx1′ so substitute tx1 into eq. (6) to obtain the height at the time and compare with the height of grids;

For line section [tx1′tx2], because t_{z} appeared in this section, the minimum height occurred appeared at t_{z}, so substitute t_{z} into equation (6) to obtained the height and compare with the height of the grids;

For line section [tx2′ty2], the flying height at this time is incremental, thus the minimum flying height occurred at tx2, so substitute tx2 into eq. (6) to obtain the height at the time and compare with the height of the grids;

For line section [ty2′tx3], the flying height at this time is incremental, thus the minimum flying height occurred at ty2, so substitute ty2 into eq. (6) to obtain the height at the time and compare with the height of the grids;

For line section [tx3′tx4], the flying height at this time is incremental, thus the minimum flying height occurred at tx3, so substitute tx3 into eq. (6) to obtain the height at the time and compare with the height of the grids;

For line section [tx4′ty3], the flying height at this time is incremental, thus the minimum flying height occurred at tx4, so substitute tx4 into eq. (6) to obtain the height at the time and compare with the height of the grids;

For line section [ty3′tx5], the flying height at this time is incremental, thus the minimum flying height occurred at ty3, so substitute ty3 into eq. (6) to obtain the height at the time and compare with the height of the grids;

For line section [tx5′t_{f}], the flying height at this time is incremental, thus the minimum flying height occurred at tx5, so substitute tx5 into eq. (6) to obtain the height at the time and compare with the height of the grids.

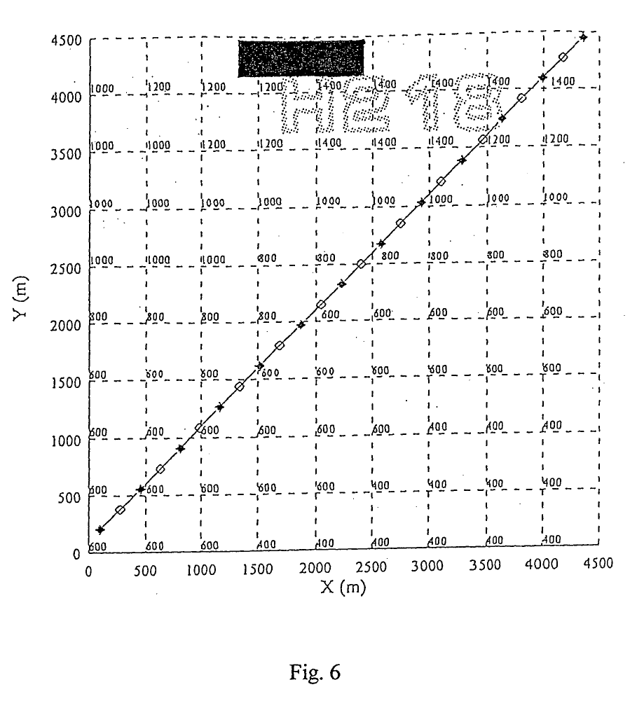

Now turning to FIG. 6, is shown a simulation of terrain data, which assume the following physical quantities:

V_{0H}=2000 knot˜100 m/s; V_{Z}=−60 m/s; a_{Z}=0.25 g=2.45 m/s²

ψ=45°; x₀=100 m; y₀=200 m; z₀=1500 m

wherein 0.25 g is the scrambler accelerating speed of the FLTA standard, and the time of predictable path is 60 seconds. The physical quantities above are inputted into eq. (4), (5) and (6) to obtain the kinematics equations:

x=100+100×sin ψ×t

y=200+100×conψ×t

z=1500−60×t+½×2.45×t²

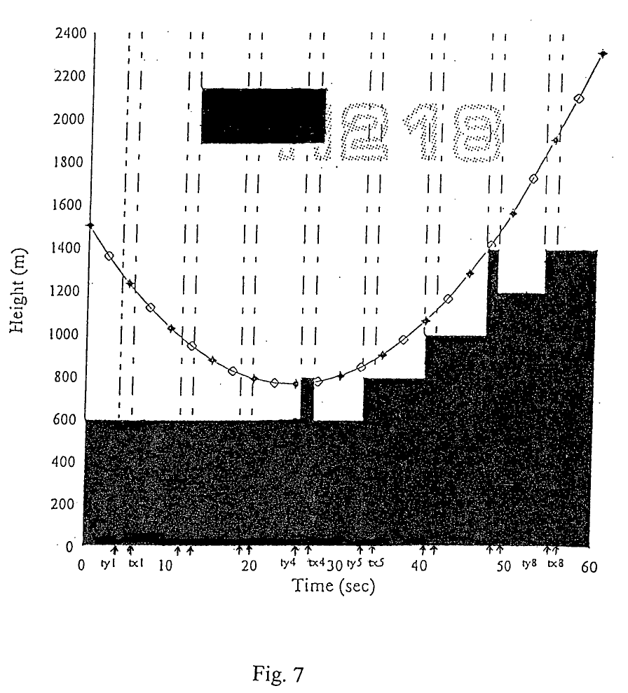

FIG. 6 also shows a predictable path of an airplane over the xy plane during the 60 seconds interval, if the vertical height of this path is placed onto the cross section of the terrain, as shown in FIG. 7.

From FIG. 7, it is obvious to see that the aircraft may run into an earth collision situation, such as time intervals between t_{y4}-t_{y4} and t_{y7}-t_{y7}. Under such a situation, if it a traditional constant interval sampling method is used, there is no way to detect hazardous situation. Even if the sampling repetition is doubled, there is still no way to detect hazardous situation. In contrast, if the data collision detecting method for forward looking terrain is used problems associated with detecting the hazardous situation are readily and entirely solved by detecting the situation on a timely basis.

TABLE 1
shows sampling positions of the grid terrain data collision
detecting method for forward looking terrain avoidance of
the present invention.

| time (sec) | x (m) | y (m) | z (m) |
|---|---|---|---|
| 4.24 | 399.76 | 500.00 | 1268 |
| 5.66 | 500.00 | 600.32 | 1200 |
| 11.31 | 899.36 | 1000.00 | 978 |
| 12.73 | 1000.00 | 1100.72 | 935 |
| 18.38 | 1398.97 | 1500.00 | 811 |
| 19.81 | 1500.00 | 1601.12 | 792 |
| 25.45 | 1898.57 | 2000.00 | 766 |
| 26.88 | 2000.00 | 2101.51 | 772 |
| 32.51 | 2398.17 | 2500.00 | 844 |
| 33.95 | 2500.00 | 2601.91 | 875 |
| 39.58 | 2897.77 | 3000.00 | 1044 |
| 41.03 | 3000.00 | 3102.31 | 1100 |
| 46.65 | 3397.37 | 3500.00 | 1367 |
| 48.10 | 3500.00 | 3602.71 | 1448 |
| 53.72 | 3896.98 | 4000.00 | 1812 |
| 55.18 | 4000.00 | 4103.11 | 1919 |

In comparison to traditional grid terrain data collision detecting methods, the present invention requires calculation of only 11 sampling position points with 5 seconds of repetition time and 23 sampling position points with 2.5 seconds of repetition time.

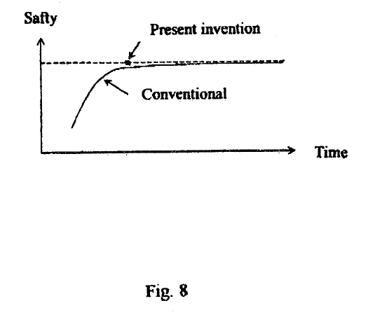

Although the calculation of sampling position points of the present invention is slightly more than traditional, so as to ensure approximately 100% security and prevent the possibility of collision, and as a whole the method of the present invention has better efficiency and is more secure. FIG. 8 compares security and efficiency between the present invention and traditional terrain data collision detecting methods.

From above description, it is understood that the grid terrain data collision detecting method for forward looking terrain avoidance of the present invention is capable of ensuring 100% security without any probability influences, and the calculation time is stable and efficiency and security benefits are enormous.

Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. A grid terrain data collision detecting method for forward looking terrain avoidance comprising the following steps: using kinematics equation to analytically find out position sampling points; processing the sampling points in sequence with increment of time; and using function minimum value theory to detect collision with the result from the second step.

2. The grid terrain data collision detecting method as in claim 1, wherein, during the kinematics equation analytical step, when the directional angle is 0 or 180 degree use ty=(my×Ry−y₀)/V_{0H} con ψ to find positions of sampling points; and when the directional angle is 90 or 270 degree use t_{X}=(mx×R_{X}−X₀)/V_{0H} sin ψ to find positions of sampling points.

3. The grid terrain data collision detecting method as in claim 1, wherein, during the sampling points processing step, results from the kinematics equation analytical step are arranged into two sets of sampling points based on time increment, with time incremental relationship as follows:
t₀<t_{y1}<tₓ₁<tₓ₂<t_{y2}<tₓ₃<tₓ₄<t_{y3}<tₓ₅<t_{f}.

4. The grid terrain data collision detecting method as in claim 1, wherein the application of function minimum value theory is for differentiating
z=z₀+V_{0z}t+½ a_{z}t²
and setting the result equal to zero to yield the timing of the lowest point t_{Z}=−(V_{0Z}/a_{Z}); and said timing can be used as a checking point during implementation of the collision detection to compare each line section one by one.
